(19) United States
(12) Patent Application Publication
(10) Pub. No.: US 2026/0006055 A1
(43) Pub. Date: Jan. 1, 2026

(54) SYSTEM AND METHOD FOR PREDICTIVE PROTECTION OF CLOUD-BASED APPLICATIONS AND SERVICES

(71) Applicant: Salesforce, Inc., San Francisco, CA (US)

(72) Inventor: Jose Lejin P J, Bengaluru (IN)

(73) Assignee: Salesforce, Inc., San Francisco, CA (US)

(21) Appl. No.: 18/757,523

(22) Filed: Jun. 28, 2024

(51) Int. Cl. H04L 9/40

(52) U.S. Cl. CPC H04L 63/1433; H04L 63/02

(57) ABSTRACT

Apparatus and method for predictive protection of cloud-based applications and services. For example, a web application firewall (WAF) detects vulnerabilities in the data traffic and collects relevant information including, for example, the payload type, structure, and specific vulnerability information. For certain vulnerabilities associated with views, the view document object model (DOM) and history of views may be collected. For vulnerabilities related to API calls, the corresponding the API path and history of API calls may be retrieved. The WAF includes a signature controller which decodes the payload (e.g., the JavaScript Object Notation (JSON) structure) and creates a signature of the vulnerability based on the relevant information including, but not limited to, the API path, the web application domain, and/or the URL path. The WAF distributes collected and generated vulnerability information to web browser extensions of the web application which perform mitigations such as generating notifications when a vulnerability is encountered.

### TECHNICAL FIELD

One or more implementations relate to the field of computer systems for providing data processing services; and more specifically, to a system and method for predictive protection of cloud-based applications and services.

### BACKGROUND ART

The majority of cloud-based solutions, devices, and applications are delivered in the form of web applications provided by web services. A web application firewall (WAF) is a specific type of application firewall configured to inspect, filter, detect and block HTTP traffic between web applications and the Internet. In particular, a WAF may implement security techniques to protect a web application from vulnerabilities such as broken authentication, cross-site forgery, cross-site-scripting (XSS), file inclusion, injection attacks, and many other vulnerabilities. A WAF works in Layer 7 (L7) of the Open Systems Interconnection (OSI) model and is referred to as a L7 WAF.

A WAF will typically be deployed between the web application service and the internet. The biggest drawback associated with this arrangement is that vulnerabilities can only be detected when a payload transmitted from the client side reaches the server side where the WAF is deployed. Consequently, these vulnerabilities may have already caused issues on the client side prior to transmission. Following transmission, the vulnerable payload may be passed through various intermediate hops before reaching the WAF.

When a web application service is a widely-deployed cloud solution, the risk of certain types of attacks, such as SQL injections in REST call payloads, are elevated. In this scenario, multiple instances of the same web application may be running concurrently across different users in different web browsers, each of which will be sending traffic with similar vulnerabilities. When a vulnerability is detected on one of the instances by one of the WAF deployments, the same vulnerability may be present in all of the other instances of the web application. If the vulnerability is associated with a specific view or a specific endpoint call, for example, then other instances of the web application will likely trigger the same vulnerability, resulting in a heavy load on the WAF. Given that all of these detected and reported vulnerabilities are based on the same underlying web application, requiring the WAF to detect and report each web application instance of the vulnerability is inefficient.

Existing client-side WAF solutions also fail to solve these problems. These client-side solutions lack the capabilities and power required to detect and correct the wide range of potential vulnerabilities, which may change dynamically and which can only be detected on server-side WAF deployments. Moreover, it is not possible to control the organization-level large scale WAF protections in this kind of deployment.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 illustrates a plurality of browsers running different instances of a web application and a web application firewall (WAF) configured between the browsers and a corresponding web server cluster which provides services for the web application.

FIG. 2 illustrates functional of a browser extension and a WAF in accordance with embodiments of the invention.

FIG. 3 illustrates a user experience (UX) design for generating an alert in response to a detected vulnerability related to a web application view.

FIG. 4 illustrates a UX design for generating an alert in response to a detected vulnerability related to an application programming interface (API) call.

FIGS. 5A-B illustrates a method in accordance with embodiments of the invention.

FIG. 6A illustrates an example electronic device on which embodiments described herein may be implemented.

FIG. 6B illustrates an example system on which embodiments described herein may be implemented.

### DETAILED DESCRIPTION

Implementations of the invention solve the inefficiencies associated with current WAF configurations, providing improved protection for multiple instances of a web application in real time, when a vulnerability is detected. These implementations include a server-side web application firewall (WAF) and a corresponding client-side pluggable web browser extension for implementing the techniques described herein. In accordance with these implementations, the WAF is configured between the web browser extensions and corresponding web server clusters to evaluate corresponding request-response traffic for vulnerabilities.

In some implementations, a vulnerability controller of the WAF detects vulnerabilities in the data traffic and collects relevant information including, for example, the payload type, structure, and specific vulnerability information. For certain vulnerabilities associated with views, the view document object model (DOM) and history of views accessed may be retrieved from the local storage of the web browser. For vulnerabilities related to API calls, the corresponding the API path and history of API calls may be retrieved from the local storage. In some implementations, the WAF also decodes the payload (e.g., the JavaScript Object Notation (JSON) structure) and creates a signature of the vulnerability based on the relevant information including, but not limited to, the API path, the web application domain, and/or the URL path.

A WebSocket connection or other persistent bi-directional connection may be opened and maintained with each respective browser extension so that information can be exchanged in real time with the WAF. For example, upon detecting a potential vulnerability, the WAF uses the WebSocket connection to retrieve the relevant information from the respective browser. If the WAF confirms the existence of a vulnerability, it uses the WebSocket connections to provide vulnerability information to the corresponding browser extensions, which can then use the vulnerability information to detect conditions capable of triggering the vulnerability, such as access to a particular domain or sub-domain. In some implementations, when these conditions are detected, the WAF transmits the corresponding vulnerability signature to the browser extension, which can then use the signature to precisely determine whether the vulnerability conditions are present and, if so, perform operations to mitigate the vulnerability and/or notify users and web application administrators. The vulnerability information and signature may also be communicated to one or more administrators so that subsequent versions of the web browser extension and/or web application can be updated in accordance with the detected vulnerabilities.

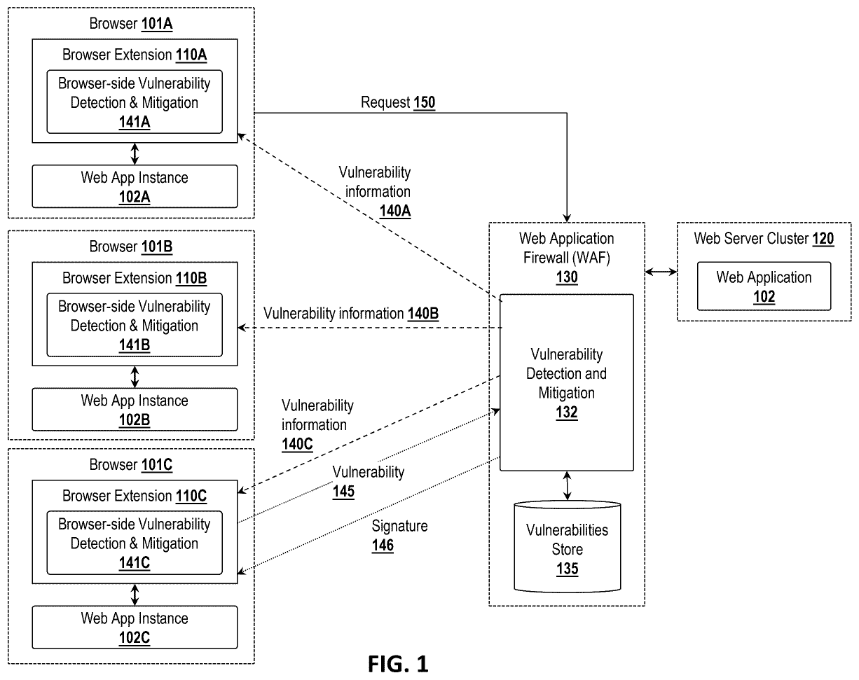

FIG. 1 illustrates one implementation of a WAF 130 deployed in front of a web application 102 hosted by a web server cluster 120. In the illustrated example, browsers 101A, 101B, and 101C have running web application instances 102A, 102B, and 102C, respectively, and also include instances of a web browser extension 110A-110C running in the web browser. In the illustrated implementation, the WAF 130 includes vulnerability detection and mitigation logic 132 which monitors for vulnerabilities in requests directed to the web application 102, such as request 150 originating from browser 101A. In these implementations, when the vulnerability detection and mitigation logic 132 detects a vulnerability or a potential vulnerability in a request 150 it collects relevant information from the corresponding browser extension 110A which it stores in a vulnerabilities store 135 (e.g., with other vulnerability data collected from various other browser extensions). The relevant information may include, by way of example and not limitation, the payload type, relevant API calls, the document/data structure, the view document object model (DOM), and a history of views accessed by user which is maintained by the browser extension 110A.

When the WAF confirms a vulnerability, the vulnerability detection and mitigation logic 132 may provide vulnerability information 140A-C usable by browser-side vulnerability detection and mitigation logic 141A-C to detect conditions capable of triggering the vulnerability, such as accessing a particular domain or path within the domain. For example, the vulnerability information may be passed as an indication of a domain and path corresponding to the vulnerability.

In addition, the vulnerability detection and mitigation logic 132 of the WAF 130 generates a signature which can be used to precisely identify subsequent instances of the detected vulnerability (e.g., potentially originating from other browser extensions) and stores the signature in the vulnerabilities store 135. For example, the vulnerability detection and mitigation logic 132 may decode any JavaScript Object Notation (JSON) structure from the payload of the request 150 and create a signature based on the decoded data. The signature may include one or more of: the initiated view, the API path, the web application domain, and the uniform resource locator (URL) path. This data, or portions thereof, may be concatenated to produce the signature. A key (e.g., a symmetric key or a non-symmetric key of a key pair) may also be used to generated the signature over the concatenated data, or portions thereof.

When a browser extension 110C detects conditions associated with a vulnerability based on the provided vulnerability information 140C (e.g., a user arriving at a domain and path corresponding to the vulnerability), the browser extension 110C may send a request 145 to the vulnerability detection and mitigation logic 132 indicating the vulnerability conditions. In response, the vulnerability detection and mitigation logic 132 transmits the previously generated signature 146 associated with the vulnerability, which the browser extension 110C can then use to precisely identify the vulnerability and perform mitigation operations including generating alerts to users/administrators (as described further below).

Thus, these embodiments provide for collaborative, real time vulnerability protection on the client browser as soon as a new vulnerability is detected, significantly reducing the load on the WAF 130, which is no longer required to detect each and every instance of a given vulnerability. These embodiments also ensure that vulnerabilities will not be initiated from the browser side and only detected upon a request reaching the WAF, thereby providing active protection from specific vulnerabilities before they occur.

In some embodiments, vulnerabilities detected by the vulnerability detection and mitigation logic 132 are persistently stored and communicated to administrators of the browser extensions 110A-C and/or the web application 102, so that the vulnerabilities can be mitigated in subsequent versions of the extensions 110A-C. As described below, when a particular vulnerability is mitigated in a new version of the web application 102, the corresponding vulnerability data may be flushed from the vulnerabilities store 135. In some implementations, the WAF identifies each vulnerability with a unique identifier, which it communicates to administrators and which it uses to flush vulnerability data which is no longer needed.

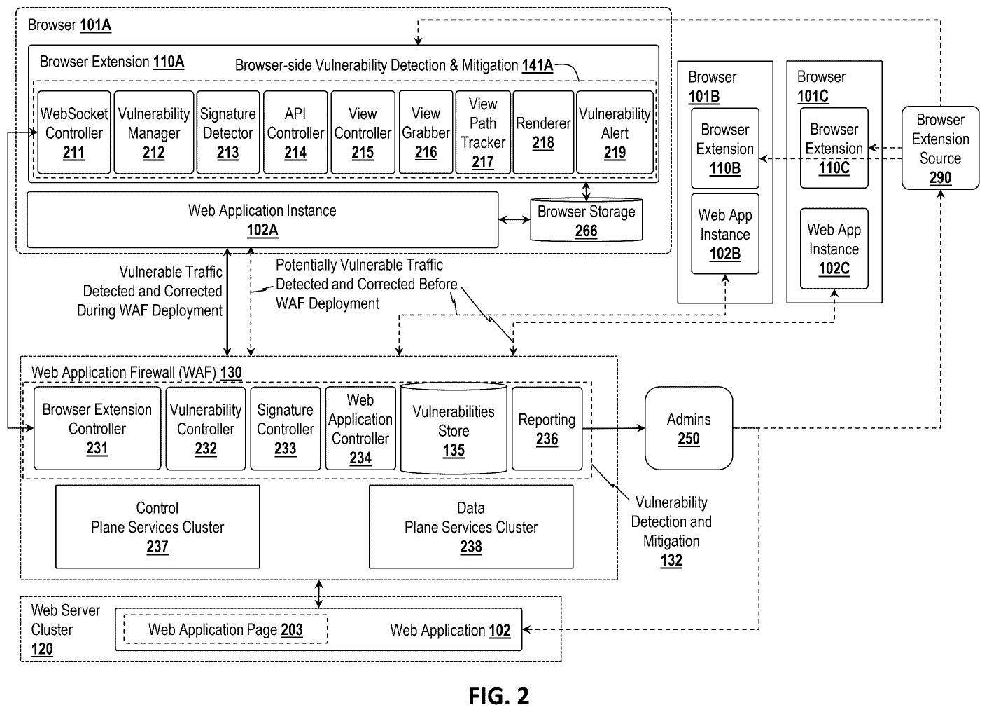

FIG. 2 illustrates additional details for one implementation of the WAF 130 deployed in front of the web server cluster 120 which hosts the web application 102. In the illustrated example, the illustrated WAF 130 has a split architecture including a control plane services cluster 237 for managing control functions and a data plane services cluster 238 for performing data management operations. Each cluster 237-238 may be implemented as a cluster of server machines in accordance with the expected load on the WAF. As described with respect to FIG. 1, web browsers 101A, 101B, and 101C include the web application instances 102A, 102B, and 102C, respectively, and also include instances of a corresponding web browser extension 110A-110C provided by a browser extension source 290 (e.g., a cloud service, such as a web browser app store, from which software can be downloaded and installed).

Various specific components 211-219 of the browser-side vulnerability detection and mitigation logic 141A are described below in combination with components 231-236 of the vulnerability detection and mitigation logic 132 of the WAF 130. As mentioned, when the web application 102 is initially requested by the web browser 101A (e.g., in response to input from a user), the first point of contact before reaching the web server cluster 120 is the WAF 130, which responsively accesses the corresponding web application 102 from the web server cluster 120. In some embodiments, a web application controller 234 injects logic into a web application page 203 (e.g., JavaScript-based code) which causes the browser 101A to check for the browser extension 110A and generate a prompt to install it from the browser extension source 290, if not already installed. By way of example, and not limitation, the logic injected by the web application controller 134 may cause the browser 101A to check for the presence of an extension-specific JavaScript object in the running instance of the web application 102B, which indicates the presence of the browser extension 110A.

A WebSocket controller 211 integral to the browser extension 110A establishes a persistent bidirectional communication channel with a browser extension controller 231 of the WAF 130 (e.g., via the WebSocket communication protocol). In this embodiment, the persistent connection is used to dynamically provide requested information from the browser extensions 110A-C to the browser extension controller 231 and to receive the vulnerability information 140A-C generated by the WAF 130 as described herein.

View-based vulnerabilities may be associated both with an active view and a view history generated by the web application instance 102A. As used herein, the active view comprises the current page rendered within the browser 101 and associated data (e.g., a particular HTML page with data input fields corresponding to specific data types, specific graphical elements and text elements, etc) and a view history comprises the particular sequence of views traversed within the browser 101 to reach the active view. In one embodiment, a view controller 215 detects the active view associated with the web application instance 102A by accessing the corresponding root HTML element identifier (ID). A view grabber 216 maintains the latest view in a local browser storage 266 (e.g., window.localStorage) by retrieving the Document Object Model (DOM) along with the associated cascading style sheets (CSS) styles, in a text format. A view path tracker 217 maintains the historical path to reach the active view in local browser storage 266, starting from the initial view provided by the web application instance 102A and ending with the active view. To maintain the historical information, when traffic is initiated from a particular view, the view path tracker 217 may insert a corresponding view root HTML element ID as a header view ID.

Vulnerabilities may also be associated with specific types of API calls (e.g., representational state transfer (REST) calls) generated from the web application instance 102A, which may be indicated in the vulnerability information 140A-C provided by the vulnerability detection and mitigation logic 132. In some embodiments, an API controller 214 of the browser extension 110A detects these API calls, for example, by listening for custom XMLHttpRequest objects, and may store a history of the API calls within the browser storage 266.

When the running web application instance 102A sends traffic with vulnerabilities to the web server cluster 120, a vulnerability controller 232 detects these vulnerabilities and collects relevant information including, for example, the payload type, data/document structure, and specific vulnerability information. In addition, the browser extension controller 231 may retrieve the view DOM and history of views from the local browser storage 266 if relevant (e.g., via the WebSocket connection).

In some implementations, a signature controller 233 of the WAF 130 decodes any JavaScript Object Notation (JSON) structure from the payload and creates a signature of the vulnerability based on relevant information such as the initiated view, the API path, the web application domain, and the URL path (e.g., a concatenation of the relevant information and/or using a key to generate a signature). The collected data and signature may be preserved in the vulnerabilities store 135 which can be implemented as a local or remote database (e.g., SQL or non-SQL) or other type of data storage structure. If the vulnerability is associated with the view, then the DOM and view history may also be stored in the vulnerabilities store 135.

As mentioned, a plurality of other instances of the web application 102B-C may be running on different browsers 101B-101C with corresponding browser extensions 110B-C configured with the same functionality as described with respect to browser extension 110A. The corresponding WebSocket controllers maintain real time WebSocket connections to synchronize with the browser extension controller 231 as described with respect to WebSocket controller 211. In some implementations, current active vulnerabilities are passed from the vulnerabilities store 135 in real time to the browser extensions 110A-C over the corresponding WebSocket connections so that each browser extension can detect conditions which trigger the vulnerability.

The vulnerability information may be sent as soon as the vulnerability is detected or shortly thereafter, to each of the browser extensions 110A-C, which use the vulnerability information to locally detect conditions associated with vulnerabilities, take corresponding actions, and provide notifications to end users, as described herein. For example, a vulnerability manager 212 of the browser extension 110A (as well as other instances of the vulnerability manager running in the other browser extensions 110B-C) evaluates the current state and configuration of the corresponding web application instance 102A to determine whether it has active vulnerabilities based on the vulnerability information 140A. If so, then the corresponding signature generated by the signature controller 233 is passed to the signature detector 213 of the browser extension 110A which parses the signature and passes information related to corresponding views to the view controller 215 and information related to corresponding API calls to the API controller 214.

As mentioned, the active vulnerabilities detected and the corresponding browser-side information may be communicated by each browser extension 110A-C to the WAF 130 through the bi-directional persistent connection, which may be, for example, a WebSocket connection.

In some implementations, reporting logic 236 on the WAF 130 aggregates and consolidates the information collected from one or more browser extensions and passes it (e.g., periodically, on demand, etc) to administrators 250 so that it may be considered when developing the next version of the browser extension 110A-C and/or the web application 102. The aggregated information may be provided by the reporting logic 236 via any form of electronic messaging such as email (e.g., with a link to the underlying data), instant messengers, or using any other electronic messaging application. Since view DOM and the view path history are also stored in the vulnerabilities store 135 and provided by the reporting logic 236, if a vulnerability is related to a view, an administrator can efficiently locate it and mitigate the vulnerability.

In these implementations, as the owner of the web application 102 mitigates identified vulnerabilities, the corresponding information may be flushed out of the vulnerabilities store 135 and the corresponding browser extensions 110A-C. As mentioned, the data associated with each vulnerability may be identified in the vulnerabilities store 135 with a unique identifier, which may be used to flush data for vulnerabilities which have been mitigated in the web application 102. Thus, once a vulnerability is mitigated in the web application 102, it will no longer generate an alert or mitigation actions by the browser extension 110A-C.

In some implementations, vulnerability alert logic 219 detects when any of the views associated with a vulnerability are generated on the browser 101A. A particular view may be detected, for example, based on the corresponding root HTML element ID of the active view. In response to arriving at this specific view, the web application instance 102A, generates an alert in accordance with a specific user experience (UX) design.

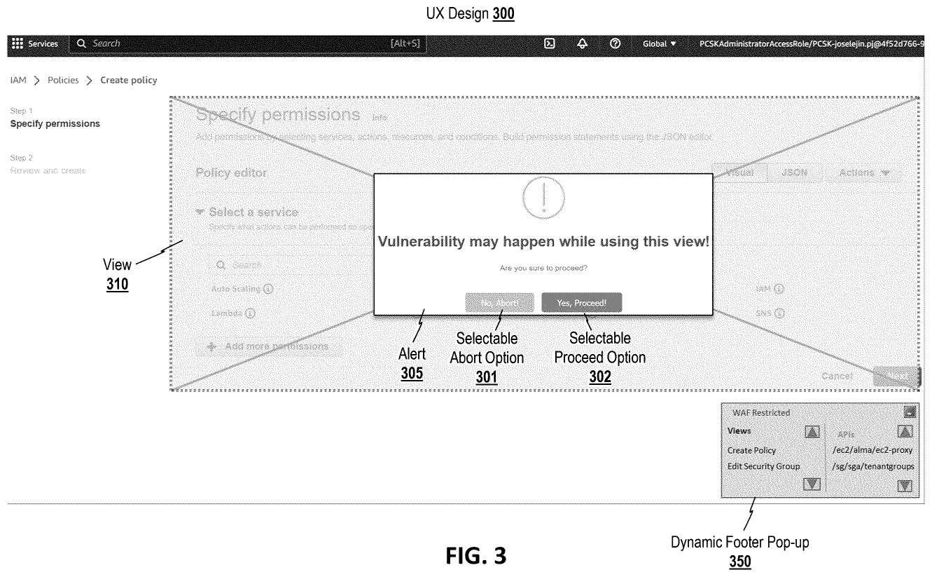

FIG. 3 illustrates an example of a UX design 300 for generating an alert in accordance with embodiments of the invention. When a view 310 is detected which has a known vulnerability, vulnerability alert logic 219 may initiate security actions and alert the user. In addition, the HTML elements of the view may be disabled by the renderer 218 of the browser extension 110A by default, proactively mitigating the vulnerability. In the illustrated example, the view 310 is modified with a specified opacity value or otherwise greyed out to indicate that it is disabled. In addition, an alert window 305 may be generated over the view 310 providing a warning that use of the view may result in a vulnerability. In this embodiment, the alert window includes two selectable options: an abort option 301 to abort entry into the view 310 and a proceed option 302 to allow entry into the view. If the abort option 301 is selected, then the prior view (not shown) may be re-rendered and presented on the display, going away from the view 310 and if the proceed option 302 is selected, then the view 310 may be rendered.

In some implementations, only the abort option 301 may be provided within the alert window 305, or the options provided may be based on the privileges of the logged-in user. For example, an administrator or other user with sufficient privileges may be provided both the abort option 301 and proceed option 302 while standard users with limited privileges may be provided with only the abort option 301.

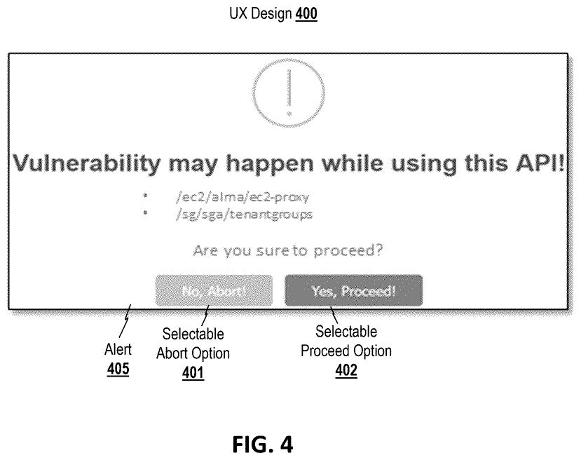

Similarly, if the web application instance 102A triggers (or will trigger) an API call detected by the API controller 214 of the browser extension 110A, the vulnerability alert logic 219 may initiate security actions and alert the user. FIG. 4 illustrates another UX design for alerting the user to vulnerable API calls. When an API call with a known vulnerability is detected (e.g., detected based on use of the specific API by one of the web applications instances 102A-C), the renderer 218 may generate an alert window 405 with the selectable abort option 401 to abort the API call and a selectable proceed option 402 to allow the API call to proceed, as well as an alert message indicating that use of the API may result in a vulnerability (and potentially an indication of the specific API components associated with the vulnerability). If the abort option 401 is selected then the API call will be dropped and if the proceed option 402 is selected, then the API call will be made.

In both UX designs 300, 400, the browser extension 110A may automatically cause the renderer 218 to render a dynamic footer pop-up 350, showing the title name of views and API paths which corresponding to users aborting the corresponding operations. In these implementations, the renderer 218 may generate the UX screen views using CSS and scalable vector graphics combined with JavaScript logic. The disabling of the view 310 may be implemented using the CSS disable option, along with a level of opacity to provide the appearance of being disabled.

The dynamic footer pop-up 350 helps the end user to gain a clear picture on reported vulnerabilities associated with all views and APIs (in cases where users took action to abort). This summary information is useful when a web app is used for business-critical systems like CRM Systems GUI, Salesforce Business Forms GUI, AWS Console GUI etc. Users of these systems are generally administrators or critical users who need to have visibility of issues in running the web application.

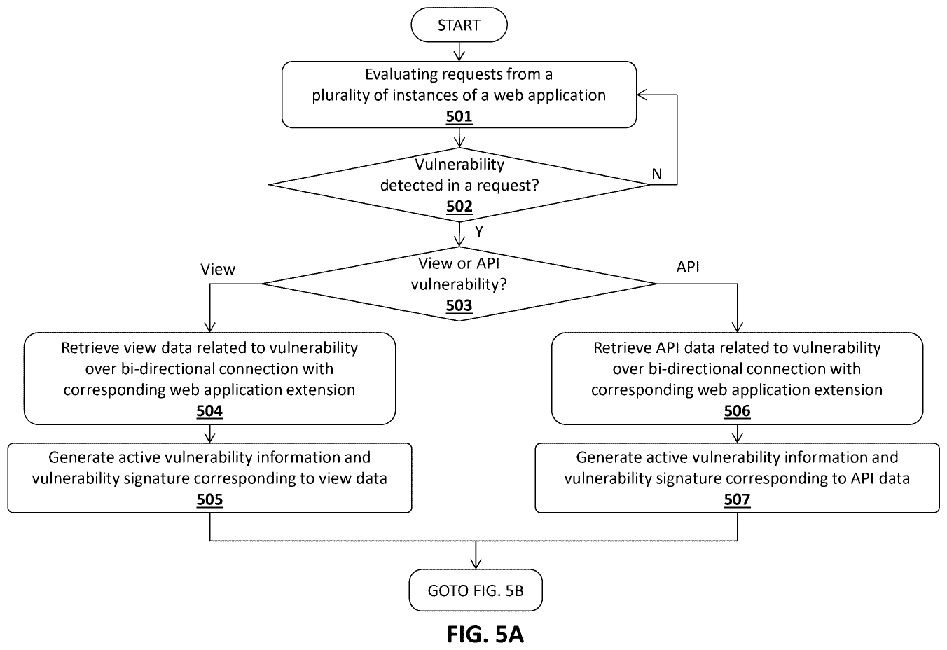

A method in accordance with embodiments of the invention is illustrated in FIGS. 5A-B. The method may be implemented on the various system architecture described herein, but is not limited to any specific architecture, protocol, or framework.

At 501, requests received from a plurality of instances of a web application are evaluated for vulnerabilities. When a vulnerability (or potential vulnerability) is detected at 502, then if the vulnerability is associated with a view, determined at 503, the view data related to the vulnerability is retrieved over a bi-directional connection with the corresponding web application browser extension at 504. At 505, active vulnerability information is generated as well as a vulnerability signature corresponding to the view data.

If the vulnerability is associated with an API call at 503, then at 506, the corresponding API data is retrieved over the bi-directional connection with the corresponding web application browser extension. At 507, active vulnerability information is generated as well as a vulnerability signature corresponding to the API data.

In some implementations, if an updated version of the web application or patches are available which resolve the vulnerability, the notifications described with respect to FIGS. 3-4 may indicate the updated version or patches as a recommendation or a requirement to proceed (e.g., with a link directing the browser to the browser extension source 290).

Turning to FIG. 5B, at 508, the active vulnerability information is passed over the bi-directional connection to the plurality of running instances of the web application. The active vulnerability information may comprise a relatively small amount of data, such as an indication of a domain and path within the domain. Each instance of the browser extension locally stores the active vulnerability information, which it uses to determine conditions on the web application instance corresponding to the active vulnerability, as determined at 509.

In response to a browser extension detecting conditions associated with the active vulnerability, the vulnerability signature is passed over the bi-directional connection to the corresponding browser extension at 510. If the signature confirms the vulnerability, determined at 511, then at 512 the browser extension performs one or more vulnerability mitigation operations, including pausing operation of the web application and generating an alert to the user, as described above with respect to FIGS. 3 and 4. In addition, if an updated version of the web application or patches are available which resolve the vulnerability, the updated version or patches may be provided as a recommendation or a requirement to proceed (e.g., with a link directing the browser to the browser extension source 290).

These embodiments enable collaborative real time protection from the client side as soon as a vulnerability is detected at the server side, providing proactive protection before a vulnerability is encountered. These embodiments also reduce the heavy load on the WAF, thereby reducing cost and improving efficiency.

### Example Electronic Devices and Environments

### Electronic Device and Machine-Readable Media

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

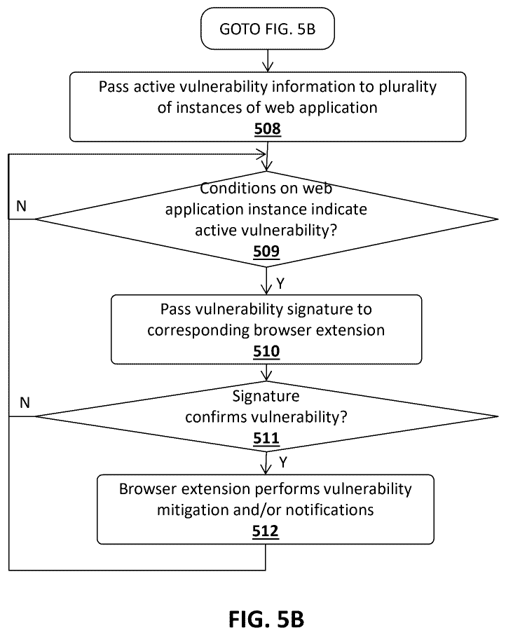

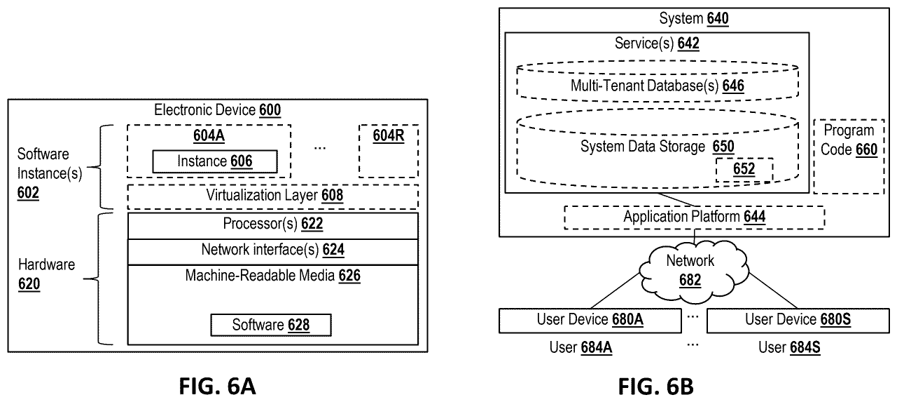

FIG. 6A is a block diagram illustrating an electronic device 600 according to some example implementations. FIG. 6A includes hardware 620 comprising a set of one or more processor(s) 622, a set of one or more network interfaces 624 (wireless and/or wired), and machine-readable media 626 having stored therein software 628 (which includes instructions executable by the set of one or more processor(s) 622). The machine-readable media 626 may include non-transitory and/or transitory machine-readable media. The web server cluster 120, WAF 130, and browsers 101A-C described herein may be implemented in one or more electronic devices 600. In this arrangement, a component sending a request is a “client” with respect to that transaction and the component providing the response is the “server”. Various components described herein may perform the role of client and server (depending on whether they are sending a request or receiving a request and providing a response). In one implementation: 1) each of the components is implemented in a separate one of the electronic devices 600 (e.g., software 628 represents a web browser, a native client, a portal, a command-line interface, and/or an application programming interface (API) based upon protocols such as Simple Object Access Protocol (SOAP), Representational State Transfer (REST), etc.)); 2) each component is implemented in a separate set of one or more of the electronic devices 600 (e.g., a set of one or more server devices where the software 628 represents the functional modules described herein software to implement the corresponding functions); and 3) in operation, the electronic devices implementing the components would be communicatively coupled (e.g., by a network) and would establish between them (or through one or more other layers and/or or other services) connections for communicating requests and receiving responses as described herein. Other configurations of electronic devices may be used in other implementations.

During operation, an instance of the software 628 (illustrated as instance 606 and referred to as a software instance; and in the more specific case of an application, as an application instance) is executed. In electronic devices that use compute virtualization, the set of one or more processor(s) 622 typically execute software to instantiate a virtualization layer 608 and one or more software container(s) 604A-604R (e.g., with operating system-level virtualization, the virtualization layer 608 may represent a container engine (such as Docker Engine by Docker, Inc. or rkt in Container Linux by Red Hat, Inc.) running on top of (or integrated into) an operating system, and it allows for the creation of multiple software containers 604A-604R (representing separate user space instances and also called virtualization engines, virtual private servers, or jails) that may each be used to execute a set of one or more applications; with full virtualization, the virtualization layer 608 represents a hypervisor (sometimes referred to as a virtual machine monitor (VMM)) or a hypervisor executing on top of a host operating system, and the software containers 604A-604R each represent a tightly isolated form of a software container called a virtual machine that is run by the hypervisor and may include a guest operating system; with para-virtualization, an operating system and/or application running with a virtual machine may be aware of the presence of virtualization for optimization purposes). By way of example, and not limitation, each web application 102 described above may be run in a separate container. Again, in electronic devices where compute virtualization is used, during operation, an instance of the software 628 is executed within the software container 604A on the virtualization layer 608. In electronic devices where compute virtualization is not used, the instance 606 on top of a host operating system is executed on the “bare metal” electronic device 600. The instantiation of the instance 606, as well as the virtualization layer 608 and software containers 604A-604R if implemented, are collectively referred to as software instance(s) 602.

Alternative implementations of an electronic device may have numerous variations from that described above. For example, customized hardware and/or accelerators might also be used in an electronic device.

### Example Environment

FIG. 6B is a block diagram of a deployment environment according to some example implementations. A system 640 includes hardware (e.g., a set of one or more server devices) and software to provide service(s) 642, such as the web application 102 and the vulnerability detection and mitigation logic 132. In some implementations the system 640 is in one or more datacenter(s). These datacenter(s) may be: 1) first party datacenter(s), which are datacenter(s) owned and/or operated by the same entity that provides and/or operates some or all of the software that provides the service(s) 642; and/or 2) third-party datacenter(s), which are datacenter(s) owned and/or operated by one or more different entities than the entity that provides the service(s) 642 (e.g., the different entities may host some or all of the software provided and/or operated by the entity that provides the service(s) 642). For example, third-party datacenters may be owned and/or operated by entities providing public cloud services (e.g., Amazon.com, Inc. (Amazon Web Services), Google LLC (Google Cloud Platform), Microsoft Corporation (Azure)).

The system 640 is coupled to user devices 680A-680S over a network 682. The service(s) 642 may be on-demand services that are made available to one or more of the users 684A-684S working for one or more entities other than the entity which owns and/or operates the on-demand services (those users sometimes referred to as outside users) so that those entities need not be concerned with building and/or maintaining a system, but instead may make use of the service(s) 642 when needed (e.g., when needed by the users 684A-684S). The service(s) 642 may communicate with each other and/or with one or more of the user devices 680A-680S via one or more APIs (e.g., a REST API). In some implementations, the user devices 680A-680S are operated by users 684A-684S, and each may be operated as a client device and/or a server device. In some implementations, one or more of the user devices 680A-680S are separate ones of the electronic device 600 or include one or more features of the electronic device 600.

In some implementations, the system 640 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 640 is a multi-tenant cloud computing architecture supporting multiple services, such as one or more of the following types of services: Pricing; Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Cache-as-a-Service (CaaS); Analytics; Community; Internet-of-Things (IoT); Industry-specific; Artificial intelligence (AI); Application marketplace (“app store”); Data modeling; Security; and Identity and access management (IAM).

For example, system 640 may include an application platform 644 that enables PAAS for creating, managing, and executing one or more applications developed by the provider of the application platform 644, users accessing the system 640 via one or more of user devices 680A-680S, or third-party application developers accessing the system 640 via one or more of user devices 680A-680S.

In some implementations, one or more of the service(s) 642 may use one or more multi-tenant databases 646, as well as system data storage 650 for system data 652 accessible to system 640. In certain implementations, the system 640 includes a set of one or more servers that are running on server electronic devices and that are configured to handle requests for any authorized user associated with any tenant (there is no server affinity for a user and/or tenant to a specific server). The user devices 680A-680S communicate with the server(s) of system 640 to request and update tenant-level data and system-level data hosted by system 640, and in response the system 640 (e.g., one or more servers in system 640) automatically may generate one or more Structured Query Language (SQL) statements (e.g., one or more SQL queries) that are designed to access the desired information from the multi-tenant database(s) 646 and/or system data storage 650.

In some implementations, the service(s) 642 are implemented using virtual applications dynamically created at run time responsive to queries from the user devices 680A-680S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 660 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 644 includes an application setup mechanism that supports application developers' creation and management of applications, which may be saved as metadata by save routines. Invocations to such applications may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 682 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 640 and the user devices 680A-680S.

Each user device 680A-680S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 640. For example, the user interface device can be used to access data and applications hosted by system 640, and to perform searches on stored data, and otherwise allow one or more of users 684A-684S to interact with various GUI pages that may be presented to the one or more of users 684A-684S. User devices 680A-680S might communicate with system 640 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 680A-680S might include an HTTP client, commonly referred to as a “browser,” for sending and receiving HTTP messages to and from server(s) of system 640, thus allowing users 684A-684S of the user devices 680A-680S to access, process and view information, pages and applications available to it from system 640 over network 682.

### CONCLUSION

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims.

What is claimed is:

1. A method implemented in a set of one or more electronic devices of a web application firewall (WAF) to detect and mitigate vulnerabilities, the method comprising:
evaluating requests from a plurality of instances of a web application to detect a vulnerability, the plurality of instances of the web application operable in browsers with browser extensions, each browser extension corresponding to one of the plurality of instances of the web application;
generating a signature corresponding to the vulnerability based on data retrieved from at least one of the browser extensions;
dynamically providing vulnerability information corresponding to the vulnerability to the browser extensions, the vulnerability information to be used by each browser extension to detect conditions capable of triggering the vulnerability;
providing the signature to at least one browser extension which has detected the conditions capable of triggering the vulnerability, the at least one browser extension to use the signature to confirm the vulnerability and, once confirmed, to responsively perform mitigation operations including generating an alert to a user or administrator of the browser extension.

2. The method of claim 1, wherein the vulnerability comprises one or both of: a view vulnerability associated with a view generated from a corresponding instance of the web application and an application programming interface (API) vulnerability generated from an API call by the corresponding instance of the web application.

3. The method of claim 2, wherein for the view vulnerability, the data retrieved from the at least one of the browser extensions comprises a view document object model (DOM), a history of views, or both.

4. The method of claim 2, wherein for the API vulnerability, the data retrieved from the at least one of the browser extensions comprises a path associated with the API call, a history of API calls, or both.

5. The method of claim 2, wherein generating an alert comprises presenting an alert window above an active view of a respective instance the web application, the alert window informing the user of a vulnerability associated with the active view or API call and providing an option to abort the active view or API call or proceed with the active view or API call.

6. The method of claim 5, wherein generating an alert further comprises presenting a pop-up window at or near a periphery of the active view, the pop-up window including a list of restricted views and APIs associated with the web application.

7. The method of claim 1, further comprising:
establishing persistent bi-directional communication channels with the browser extensions, wherein the data retrieved from the each of the browser extensions is to be provided over at least one corresponding persistent bi-directional communication channel, and wherein dynamically providing vulnerability information and providing the signature to the at least one browser extension are performed over at least one corresponding persistent bi-directional communication channel.

8. The method of claim 7, wherein the persistent bi-directional communication channels comprise WebSocket communication channels.

9. The method of claim 1, wherein the vulnerability information corresponding to the vulnerability comprises an indication of a path within a corresponding domain.

10. The method of claim 1, further comprising:
generating a report including the vulnerability information, the data retrieved from the at least one of the browser extensions, the signature, or any combination thereof; and
providing the report to an administrator to aid the administrator in mitigating the vulnerability in subsequent versions of the web application, the browser extension, or both.

11. A non-transitory machine-readable medium having program code stored thereon which, when executed by a set of one or more processors, are to cause operations, comprising:
implementing a browser extension associated with a web application instance operable within a browser, the web application instance to send requests and receive responses from a corresponding web application running on a server cluster, and the browser extension to establish a persistent communication channel with a web application firewall (WAF) configured to evaluate the requests and responses and requests and responses from other web application instances to detect a vulnerability;
receiving from the WAF vulnerability information corresponding to the vulnerability;
detecting conditions capable of triggering the vulnerability based on the vulnerability information;
receiving a signature corresponding to the vulnerability from the WAF, the signature generated based on data retrieved from another browser extension corresponding to another web application instance in which the vulnerability was detected;
confirming the vulnerability based on the signature; and
responsively performing mitigation operations including generating an alert to a user or administrator of the browser extension.

12. The non-transitory machine-readable medium of claim 11, wherein the vulnerability comprises one or both of: a view vulnerability associated with a view generated from the web application instance and an application programming interface (API) vulnerability generated from an API call by the web application instance.

13. The non-transitory machine-readable medium of claim 12, wherein the vulnerability information for the view vulnerability and the signature are generated by the WAF using the data retrieved from another browser extension corresponding to another web application instance, the data comprising a view document object model (DOM), a history of views, or both.

14. The non-transitory machine-readable medium of claim 12, wherein the vulnerability information for the API vulnerability and the signature are generated by the WAF using the data retrieved from another browser extension corresponding to another web application instance, the data comprising a path associated with the API call, a history of API calls, or both.

15. The non-transitory machine-readable medium of claim 12, wherein generating an alert comprises presenting an alert window above an active view of the web application instance, the alert window informing the user of a vulnerability associated with the active view or API call and providing an option to abort the active view or API call or proceed with the active view.

16. The non-transitory machine-readable medium of claim 15, wherein generating an alert further comprises presenting a pop-up window at or near a periphery of the active view, the pop-up window including a list of restricted views and APIs associated with the web application.

17. The non-transitory machine-readable medium of claim 11, wherein the persistent communication channel comprises a persistent bi-directional communication channel and wherein the WAF is to establish other persistent bi-direction communication channels with other browser extensions corresponding to the other web application instances.

18. The non-transitory machine-readable medium of claim 17, wherein the persistent bi-directional communication channel and the other persistent bi-directional communication channels comprise WebSocket communication channels.

19. The non-transitory machine-readable medium of claim 11, wherein the vulnerability information corresponding to the vulnerability comprises an indication of a path within a corresponding domain.

20. The non-transitory machine-readable medium of claim 11, wherein the WAF is to generate a report including the vulnerability information, the data retrieved from another browser extension corresponding to another web application instance, the signature, or any combination thereof, the report to be provided to administrator, to aid the administrator in mitigating the vulnerability in subsequent versions of the web application, the browser extension, or both.
